(19) United States
(12) Patent Application Publication
(10) Pub. No.: US 2005/0078634 A1
(43) Pub. Date: Apr. 14, 2005

(54) Network-based dormant handoff method in mobile communication system

(75) Inventor: Chang Keun Seo, Anyang-shi (KR)

Correspondence Address: FLESHNER & KIM, LLP, P.O. BOX 221200, CHANTILLY, VA, 20153, US

(73) Assignee: LG Electronics Inc.

(21) Appl. No.: 10/944,890

(22) Filed: Sep. 21, 2004

(30) Foreign Application Priority Data
Oct. 13, 2003 (KR) KR 71037/2003

(51) Int. Cl. H04Q 7/00

(52) U.S. Cl. 370/331

(57) ABSTRACT

A network-based dormant handoff method in a mobile communication system includes monitoring a change of a service area of a random terminal in a source access network, and if the change in the source access network is detected requesting a dormant handoff to a target access network as a changed service network. The method further includes connecting a packet data session for the terminal between the target access network and a packet data serving node (PDSN) according to the second step of requesting the dormant handoff, and the releasing the packet data session for the terminal between the target access network and the packet data serving node.

### BACKGROUND OF THE INVENTION

1. Field of the Invention

The present invention generally relates to mobile communication systems, and more particularly to a system and method for managing a handoff operation in a mobile communication system.

2. Background of the Related Art

In a CDMA system, if a packet data call is released by expiration of an inactivity timer and if there exists no other active call control instance, a traffic channel is released. In doing so, a Layer-3 processing state of a terminal converts to an idle mode and a corresponding packet data session and packet data service instance are shifted to a dormant state. Such a system is disclosed in ‘Interoperability Specification (IOS) for CDMA 2000 Access Network Interface’ and the radio specification ‘TIA/EIA/IS-2000.x-C’, the contents of which are incorporated herein by reference.

FIG. 1 is a block diagram of a CDMA system, which includes a packet data serving node (PDSN) 110, a plurality of PCFs 120 and 121 connected to the PDSN 110, a plurality of base stations (BSs) 130 to 133 connected to the corresponding PCFs 120 and 121, respectively, first network devices 140 and 141 to form a network. Reference number ‘10’ indicates a mobile terminal (MS) such as a notebook computer.

FIG. 2A and FIG. 2B are flowcharts of a dormant handoff process which may be performed in the CDMA system of FIG. 1. During this process, in an initial state of the MS 10, an active packet data session is first maintained, as well as one active call control instance and packet data service instance. A PPP connection is maintained between the MS 10 and the PDSN 110 (S201).

If the MS moves away into a service area of a target BS 132 from a service area of a source BS 131 during the initial state (S202), the MS detects that service can be provided to the MS via the target BS. More specifically, the MS tracks a pilot of the target BS to recognize that intensity information (Ec/Io) is of a sufficient level. The MS then transmits a (E)PSMM message to the source BS (S203).

By performing a handoff processing according to the reception of the (E) PSMM message, the system including the source BS 131 excludes a pilot of source BS 131 from an active set and includes the pilot of target BS 132 in the active set. Hence, a traffic path for providing a packet data service to a user of the MS 10 becomes PSDN 110→source PCF 120→source BS 131→target BS 132→MS 10 (S204). Thus, BS 131 drives a packet data inactivity timer while the packet data service instance is connected. The packet data inactivity timer is reset whenever a non-idle RLP frame is transmitted/received (S205).

After expiration of the packet data inactivity timer, source BS 131 transmits a Clear Request message, which sets a cause value to ‘packet call going dormant,’ to a corresponding mobile switching center (MSC) 160 to release a traffic channel (S206).

The MSC 160 transmits a Clear Command message to the source BS to instruct to release a corresponding dedicated resource (S207). The source BS then performs a traffic channel release processing, accordingly (S208).

The sources BS transmits an A9-Release-A8 message including a dormant indicator to the source PCF 120 to instruct PCF 120 to release the corresponding dedicated resource (S209).

The PCF transmits an All-Registration Request message including accounting data to PDSN 110 by setting a lifetime timer value to ‘0’ to release an A10 connection (S210). The PDSN transmits an All-Registration Reply message to PCF 120 to notify that the release of the A10 connection corresponding to the corresponding active packet data service is completed (S211).

The PCF transmits an A9-Release-A8 Complete message as a reply to the A9-Release-A8 message to the source BS (S212). The source BS 131 then transmits a Clear Complete message to the MSC.

The packet data service session of the MS is shifted to a dormant state after completion of the release process of the traffic channel in the above-explained manner. The packet data session operated by the network enters the dormant state at this time point. Hence, MS 10 performs processing of an idle state by receiving an overhead message since the packet data session and a processing state of the layer-3 (Layer3) are in the dormant state and the idle state, respectively (S214).

In the idle state, the MS monitors a broadcast channel. If detecting PZID, SID, and NID are detected to be changed, the MS 10 transmits an Origination message to the target BS 132 by setting a DRS value to ‘0’ (S210). Correspondingly, the target BS transmits a BS Ack Order message to approve the Origination message was received (S216).

Subsequently, the target BS sets an ADDS User Part value to ‘Asynchronous Data Service’ and transmits an ADDS Transfer message including the rest authentication, the MSC then transmits an ADDS Transfer Ack message as a response to the target BS (S217).

The target BS sets a DRI (data ready indicator) value to ‘0’ and transmits an A9-Setup-A8 message to target PCF 121 (S218). Accordingly, a ‘PDSN dormant HO’ procedure is executed between the target PCF and PDSN 110 in a following manner. First target PCF 121 transmits an All-Registration Request message including MEI (mobility event factor) to the PDSN (S219). If the All-Registration Request message is valid, the PDSN transmits an All-Registration Reply message to the target PCF to notify that a connection is accepted (S220). Subsequently, the target PCF transmits an A9-Release-A8 Complete message to the target BS (S221).

The target BS transmits a Release Order (with ‘normal release’) message to the MS (S222). The MS then transmits the Release Order to the target BS (S223) so that a packet data session of the MS 10 maintains ‘dormant’ state.

PDSN 110 transmits an All-Registration Update message to source PCF 120 to initiate an A10 Connection release from the corresponding PCF 120 (S224). The source PCF then transmits an All-Registration Acknowledge message to the PDSN 110 (S225).

Finally, the source PCF transmits an All-Registration Request message having a lifetime timer value set to ‘0’ to the PDSN (S226). The PDSN then transmits an All-Registration Reply message including accept indication information to source PCF 120 (S227). Accordingly, source PCF 120 releases the A10 connection for the corresponding MS.

As mentioned in the foregoing description, if the service area (PZID/SID/NID) of the terminal is changed and if the inactivity timer expires, the dormant handoff process is performed from the MS after the packet data session is shifted to the dormant state.

It frequently occurs that the ANID (PZID/SID/NID) is changed in the course of transition to the dormant packet data session mode from the active packet data session mode. This is because the MS user has mobility. Because of their mobility, the MS in the dormant packet data session mode needs the dormant handoff process for changing the A10 connection from the source PCF to the target PCF to set up a packet data call quickly in reactivation. Hence, after the traffic channel is released, the MS in the dormant packet data session mode transmits the Origination message to perform the dormant handoff. Only if such a series of procedures are completed, the MS enables to maintain the dormant state without signaling message exchange.

However, the foregoing system has at least the following problems or disadvantages. First, a plurality of signaling procedures are needed to prepare reactivation from the point in time of the packet data call release. A plurality of the signaling procedures increase the signaling overhead on the packet data service associated elements between the terminal and the network, e.g., the Origination message in the step S215 increase the load on the access channel.

Second, the time taken to perform the process of preparing the reactivation process is so long as to unnecessarily consume the battery of the terminal. More specifically, the closed loop power control is not executed when the terminal is in the access channel mode, whereby the corresponding battery consumption is raised.

Third, the time taken to perform the process of preparing the reactivation process is too long, whereby the reactivation request of the terminal user may not be accepted during the dormant handoff. Even if the reactivation request of the terminal user is accepted right after terminating the dormant handoff process in progress, prompt reactivation is impossible since the A10 connection is not established between the target PCF and the PDSN.

### SUMMARY OF THE INVENTION

An object of the invention is to solve at least the above problems and/or disadvantages and to provide at least one of the advantages described hereinafter.

Another object of the present invention is to provide a network-based dormant handoff method in a mobile communication system by which a dormant handoff is performed based on a network without message communications for the dormant handoff with a terminal by having the network recognize a state for the dormant handoff.

To achieve these and other objects and advantages, the present invention provides a network-based dormant handoff method in a mobile communication system that includes a first step of monitoring a change of a service area of a random terminal in a source access network, a second step of if the change in the source access network is detected, requesting a dormant handoff to a target access network as a changed service network, a third step of connecting a packet data session for the terminal between the target access network and a packet data serving node (PDSN) according to the second step of requesting the dormant handoff, and a fourth step of releasing the packet data session for the terminal between the target access network and the packet data serving node.

Preferably, in the first step, the source access network and more particularly a source base station (controller) enables to detect or recognize the change of the service area based on intensity information of a pilot signal received from the terminal or presence or non-presence of handoff occurrence between base stations.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

### BRIEF DESCRIPTION OF THE DRAWINGS

FIG. 1 is a block diagram showing one type of CDMA system applicable to the present invention.

FIG. 2A and FIG. 2B are flow charts of a dormant handoff process performed in a related art CDMA system.

FIG. 3 is a flowchart of a network-based dormant handoff method in a mobile communication system according to one embodiment of the present invention.

FIG. 4 is a structural diagram of a dormant handoff request message according to an embodiment of the present invention.

FIG. 5 is a structural diagram of a dormant handoff response message according to an embodiment of the present invention.

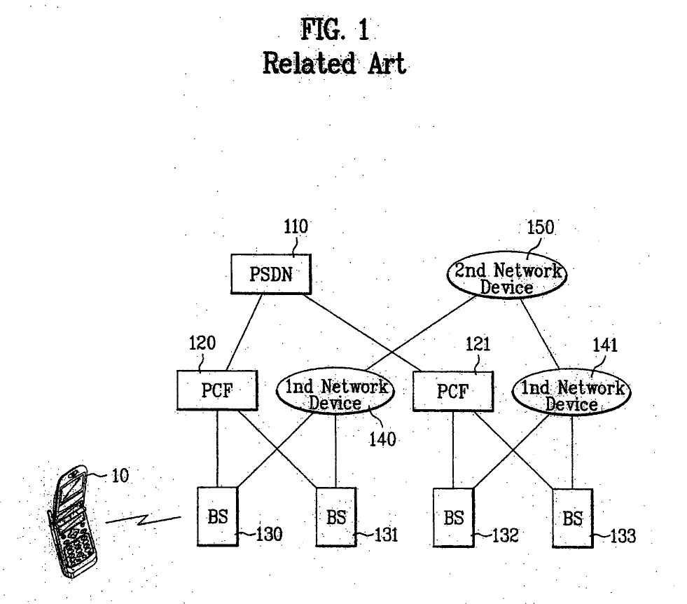

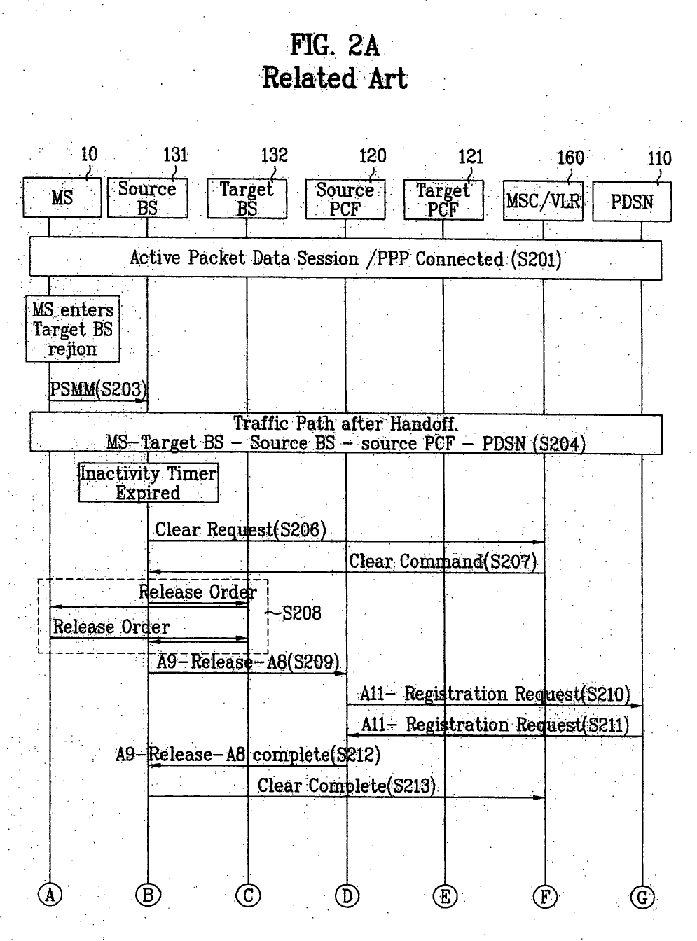

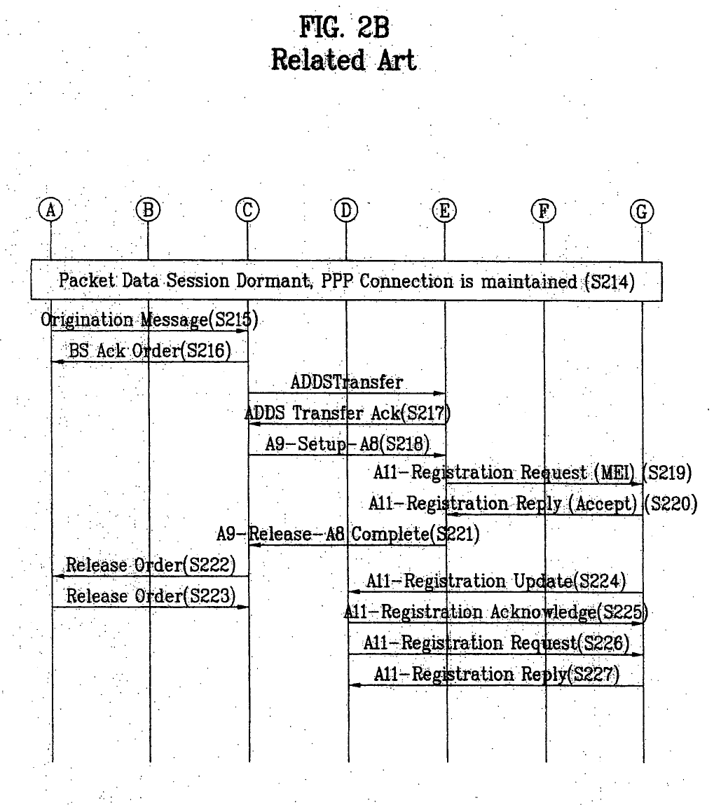

### DETAILED DESCRIPTION OF PREFERRED EMBODIMENTS

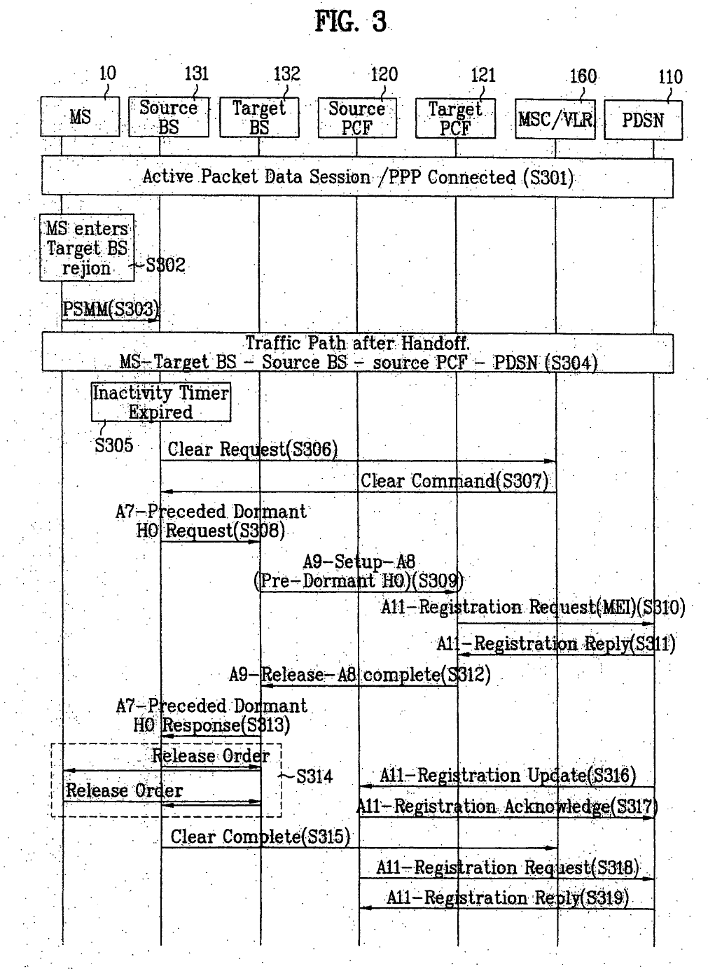

FIG. 3 is a flowchart of a network-based dormant handoff method in a mobile communication system according to one embodiment of the present invention. During an initial state of an MS 10, an active packet data session is maintained and also preferably one active call control instance and packet data service instance are maintained. Moreover, a PPP connection is maintained between the MS 10 and a PDSN 110 (S301).

If the MS moves away into a service area of a target BS 132 from a service area of a source BS 131 during the initial state (S302), the MS detects that a service is available via the target BS. More specifically, the MS tracks a pilot of the target BS to recognize that intensity information (e.g., Ec/Io) is of a predetermined level. The MS then transmits a (E)PSMM message to the source BS (S303).

By performing a handoff processing according to reception of the (E)PSMM message, the system including the source BS 131 excludes a pilot of the source BS from an active set and includes the pilot of the target BS in the active set. Moreover, while a handoff is performed between the source BS and the target BS, the target BS preferably includes an access network identifier (ID) as its position information in a handoff response (A7-Handoff Response) message transmitted to the source BS 131. Hence, a traffic path for providing a packet data service to a user of the MS becomes PDSN 110→source PCF 120→source BS 131→target BS 132→MS 10 as a result of the handoff (S304).

Thus, the source BS drives a packet data inactivity timer while the packet data service instance is connected. The packet data inactivity timer is reset whenever a non-idle RLP frame is transmitted/received (S305).

After expiration of the packet data inactivity timer, the source BS 131 transmits a Clear Request message, which sets a cause value to ‘packet call going dormant’, to a corresponding mobile switching center (MSC) 160 to release a traffic channel (S306). The MSC then transmits a Clear Command message to the source BS to instruct to release a corresponding dedicated resource (S307).

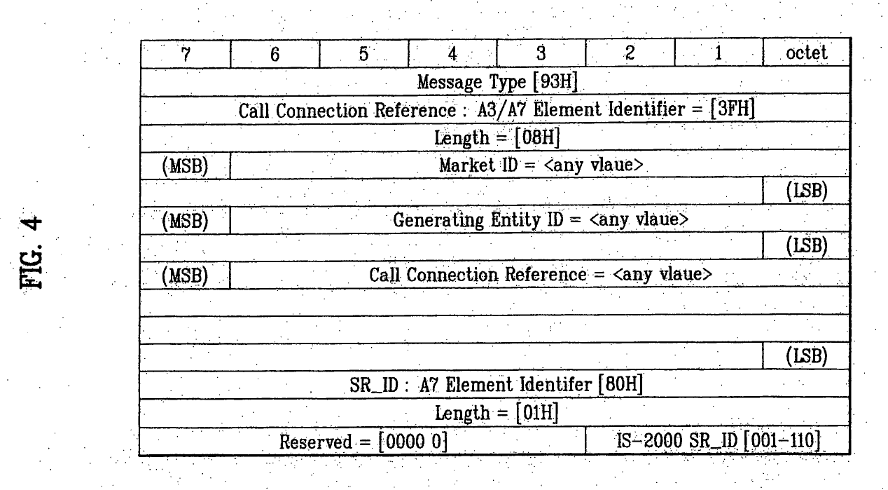

The source BS 131 recognizes that the MS currently lies in the service area of the target BS 132 and knows the access network ID, i.e., SID/NID/PZID, to which the target BS 132 belongs. Based on such a fact, the source BS transmits a message for initiating a network-based dormant handoff procedure according to the present invention (hereinafter called A7-Preceded Dormant Handoff Request message) to the target BS prior to execution of a call release according to the instruction of step S307. An example of the A7-Preceded Dormant Handoff Request message is shown in FIG. 4 (S308).

The target BS transmits an A9-Setup-A8 message to the target PCF 121 (S309). The A9-Setup-A8 message may, for example, have the same information of the conventional dormant handoff but PDH (preceded dormant handoff) is set to ‘1’. In the A9-Setup-A8 message., both DRI (data ready indicator) and Handoff Indicator are each set to ‘0.’

Target PCF 121 transmits an All-Registration Request message including MEI (mobility event indicator) information to the PDSN 110 (S310). The PDSN 110 then transmits an All-Registration Reply message including accept indication information to target PCF 121 (S311). As a result of executing the procedure, A10 connection binding information in the PDSN 110 is set for the target PCF. Also, the target PCF 121 transmits an A9-Release A8 Complete message to the target BS 132 to respond to the step S309 (S312).

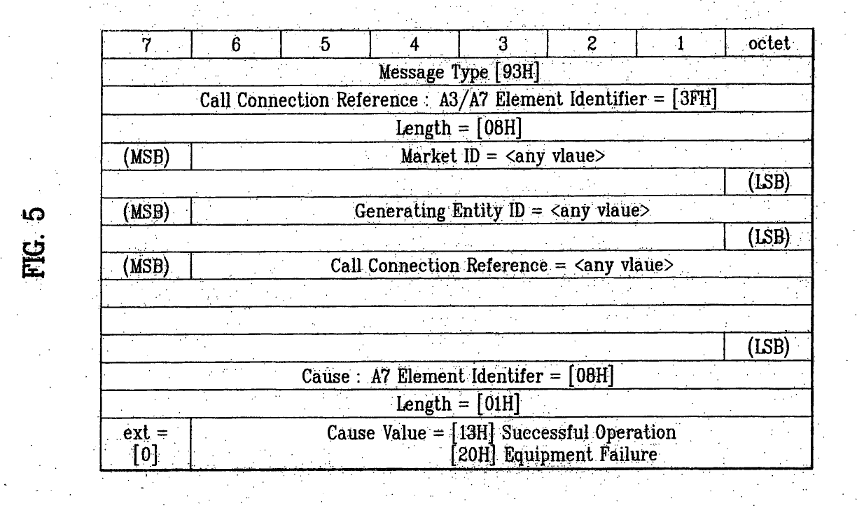

The target BS transmits an A7-Preceded Dormant Handoff Response message, which includes information (cause) that a new A10 connection setup is normally established between target PCF 121 and PDSN 110, to source BS 131 to respond to the step S308. An example of the A7-Preceded Dormant Handoff Response message is configured in FIG. 5 (S313).

As dormant handoff according to the present invention is normally completed, source BS 131 performs a call release according to the instruction of step S307. In doing so, the source BS includes “PDH ‘1” in a Release Order message to transmit. If the PDH is set to ‘1’, the terminal performs transition to the dormant state and then updates the PZID. Yet, the terminal does not perform the dormant handoff even if the previous PZID is different from the current PZID. This is because the terminal has already known that the network-based dormant handoff was performed based on the PDH information. By comparison, in the related-art method the PDH is not included in the Release Order message or Enhanced Release Order message. In accordance with at least one embodiment of the present invention, a change of the Release Order may be performed. After completion of the call release according to the instruction of the step S07, the source BS 120 transmits a release complete message to the MSC 160 to notify the completion of the call release (S314).

Preferably, in parallel with the call release procedure, a previous A10 connection release procedure is initiated between the source PCF 120 and the PDSN 110. For this, the PDSN 110 transmits an All-Registration Update message to the source PCF 120 (S316). The source PCF 120 then responds an All-Registration Acknowledge message (S317).

The source PCF 120 transmits an All-Registration Request message, which sets a lifetime to ‘0’ and includes accounting information therein, to the PDSN 110 (S318). The PDSN 110 then transmits an All-Registration Reply message including accept information to the source PCF 120 to enable the source PCF 120 release the A10 connection to the corresponding MS 10 (S319).

Accordingly, a network-based dormant handoff method in a mobile communication system according to the present invention has at least the following effects or advantages.

First, in accordance with at least one embodiment the present invention performs a signaling procedure which simpler than the related art in maintaining a dormant state enabling the prompt reactivation. More Specifically, related-art methods complete the signaling procedure by two processes of shifting the packet data session to the dormant state and performing handoff during the dormant state. The method of the present invention, on the other hand, combines the two continuous processes of the related art into one process and removes the unnecessary signaling part in the course of combining the two processes. As a result, the signaling overhead in the terminal and network is reduced to be smaller than that of the related art. And, the time taken to be ready to stand by the reactivation is shortened to be less than that of the related art.

Furthermore, the procedure of sending the Origination message to the target BS from the terminal for the dormant handoff is mandatory for related-art methods. In contrast, the present invention may perform dormant handoff based on the network to exclude such a procedure, thereby enabling to reduce the unnecessary load on the access channel. The present invention shortens the time take to stand by the reactivation, thereby enabling to prevent the reactivation from being delayed by the dormant handoff of the related art or the like in performing the reactivation procedure by terminal user's request.

Furthermore, the present invention enables to prevent the terminal from consuming the battery unnecessarily in performing the dormant handoff.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art.

1. A network-based dormant handoff method in a mobile communication system, comprising:
monitoring a change of service area of a terminal in a source access network;
if the change in the source access network is detected, requesting a dormant handoff to a target access network as a changed service network;
connecting a packet data session for the terminal between the target access network and a packet data serving node (PDSN) based on the requested dormant handoff; and
releasing the packet data session for the terminal between the target access network and the packet data serving node.

2. The method of claim 1, further comprising:
releasing a traffic channel from the terminal after completion of the connecting step.

3. The method of claim 1, wherein monitoring the change of service area is detected based on intensity information of a pilot signal received from the terminal.

4. The method of claim 1, wherein service area change information of the target access network is provided to the source access network in base station-to-base station handoff.

5. The method of claim 1, wherein the source access network is a source base station (BS).

6. The method of claim 1, wherein the target access network is a target base station (BS).

7. The method of claim 1, wherein the target access network is a target PCF.

8. The method of claim 1, wherein the source access network is a source PCF.

9. The method of claim 1 wherein connecting the packet data session includes:
transmitting a message for the dormant handoff to a target PCF from a target BS;
transmitting a connection request message for the dormant handoff to the PDSN from the target PCF; and
transmitting a response message to the connection request message from the PDSN to the target PCF, wherein the packet data session for the terminal is connected between the PDSN and the target PCF.

10. The method of claim 9, wherein the message transmitted for the dormant handoff to the target PCF is an A9-Setup-A8 message.

11. The method of claim 9 wherein the connection request message is an All Registration Request message.

12. The method of claim 11, wherein the All-Registration Request message includes MEI (mobility event indicator) information.

13. The method of claim 9, wherein the response message is an All-Registration Reply message.

14. The method of claim 1, wherein releasing the packet data session is performed by a message communication between the PDSN and a source PCF of the source access network.

15. A handoff control method, comprising:
performing a network-based dormant handoff procedure between a source base station and a target base station for a call maintained by a mobile terminal; and
transmitting a message to convert the mobile terminal to a dormant state.

16. The method of claim 15, wherein the network-based dormant handoff procedure is performed prior to execution of a call release by the source base station.

17. The method of claim 15, wherein performing includes:
transmitting a first message to initiate the network-based dormant handoff procedure from the source base station to the target base station prior to execution of the call release;
transmitting a setup message from the target base station to a target PCF, said set up message including preceded dormant handoff information; and
transmitting a registration request message including a mobility event indicator to a packet data service network.

18. The method of claim 17, further comprising:
transmitting a preceded dormant handoff response message from the target base station to the source base station, said response message including cause information indicating that a new connection has been established between the PCF and packet data service network; and
performing a call release in response to the preceded dormant handoff response message.

19. The method of claim 18, further comprising:
generating a release order message including the preceded dormant handoff information included in the set up message; and
performing the call release based on the release order message.
